(19) United States
(12) Patent Application Publication
(10) Pub. No.: US 2019/0127666 A1
(43) Pub. Date: May 2, 2019

(54) CHEMICAL COMPOSITION COMPRISING TO CLEAN AND/OR LUBRICATE FLUID ENCOMPASSING SYSTEMS

(71) Applicants: Michael Overmyer, Danville, KY (US); Thad J. OVERMYER, DANVILLE, KY (US)

(72) Inventors: Michael Overmyer, Danville, KY (US); Thad J. OVERMYER, DANVILLE, KY (US)

(21) Appl. No.: 15/801,676

(22) Filed: Nov. 2, 2017

(51) Int. Cl. C11D 3/48; C10M 105/14; C10M 133/14; C11D 3/20; C11D 3/32; C11D 3/40; C11D 11/00

(52) U.S. Cl. CPC C11D 3/48; C10M 105/14; C10M 133/14; C11D 3/2003; C10M 2215/26; C11D 3/2065; C11D 3/40; C11D 11/0041; C10M 2207/0225; C11D 3/32

(57) ABSTRACT

A single chemical composition comprising to clean and/or lubricate fluid encompassing systems and systems' components comprising of fluid conduit(s), and/or fluid reservoir(s), and/or valve(s), and/or device(s).

Fluid encompassing systems that dispense a fluid or fluids for in vitro and/or in vivo procedures and/or for consumption must be cleaned. A fluid encompassing system and this system's encompassing fluid are both susceptible to contamination

This invention's chemical composition performed routinely cleans the contamination of this system, which also helps maintain the chemical and physical properties for this system's encompassing fluid. This chemical composition also lubricates the surfaces of this system's components. Lubricating this system's components such as valves helps enhance the functioning of said system. This chemical composition also improves this system's fluid flow and helps eliminate odor and foul tasting contaminates from this system.

This chemical composition enhances fluid encompassing systems' operation and efficiency, which helps prolong the life span of these systems and said systems' components.

### BACKGROUND OF THE INVENTION

The present invention provides a single chemical composition comprising to clean and/or lubricate fluid encompassing systems. A fluid encompassing system that dispenses a fluid or fluids for in vitro and/or in vivo procedures and/or for consumption must be cleaned.

This fluid encompassing system may contain components comprising of fluid conduit(s), and/or fluid reservoir(s), and/or valve(s), and/or device(s).

A fluid encompassing system and this system's encompassing fluid are both susceptible to contamination. During the use of this system, a layer of contaminates forms within said system's components. When this fluid encompassing system is not cleaned properly, contaminates remain in this system and create a buildup of contamination. This contamination in this system will contaminate this system's encompassing fluid and said system.

The surfaces of this system's components: fluid conduit(s), fluid reservoir(s), and valve(s) are the location of the contamination. This system's encompassing fluid becomes contaminated when contacting the contaminated surfaces of this system's components. For example, this system's fluid becomes contaminated when transported through this system's contaminated fluid conduit(s); and/or this system's fluid becomes contaminated when flowing through this system's contaminated valves; and/or this system's fluid becomes contaminated when being contained in this system's contaminated fluid reservoir. Contamination affects the fluid quality of said system's encompassing fluid. Cleaning this system routinely with this invention's chemical composition will help clean the contamination in this system, which helps maintain the chemical and physical properties for this system's encompassing fluid.

Contamination forms on rubber, polyurethane, various types of metal, glass, plastic and silicone surfaces which are materials often used for said system's components: fluid conduit(s) and fluid reservoir(s).

Contamination growth in a fluid encompassing system effects many industries including healthcare, food, hospitality, and water treatment. The build-up of contamination in a fluid encompassing system can effect immunosuppressed people, system functions, aerosolization from said system's devices, encompassing's fluid flow, and tastes and odors in encompassing fluid.

Common examples of fluids that encompass a fluid encompassing system: water, milk, blood, medical solutions, fluid admixtures, cold beverages, hot beverages, frozen beverages, sodas, ice cream, yogurt, tea, fruit juice, pressurized gas, beer, wine, coffee, consumables, alcohol spirits, liquor, liqueur and other fluids that encompass a fluid encompassing system.

Some examples of a fluid encompassing system are a soda fountain machine, draft beer keg encompassing system, surgical laser system, beverage brewing machine, and a dental unit water system.

Various types of cleaning products are recommended to clean said fluid encompassing system. When a cleaning product is not completely removed from this system, this system's end product, the encompassing fluid's taste, chemical and physical properties are affected from the remnants of the cleaning product and/or contamination from said system.

Bleach based cleaning products are often used to clean a fluid encompassing system. If the bleach remnants from the bleach-based cleaning product remain in said system, these bleach remnants will alter the taste of this system's encompassing end product. For example, if this system's encompassing end product was beer, then the beer's taste will be altered from the remnants of the cleaning product in said system.

A dental unit water system will be used as a specific example to explain the importance in cleaning a fluid encompassing system and how the contributing factors for contamination grows in a fluid encompassing system. This dental unit water system will also clarify the differences between cleaning products for fluid encompassing systems compared to products and methods that treat the system's encompassing fluid. The dental unit water system will also show how a system's contaminates effects this system's fluid quality, regardless if a system's fluid was treated.

In healthcare, water is a common fluid used with a fluid encompassing system when performing medical/dental procedures upon patients. Water quality is important, especially when water is the dispensing fluid in a fluid encompassing system. Water quality is measured in CFU, colony-forming units/mL. This unit of measure is for the number of bacteria colonies found in one milliliter. Heterotrophic bacteria plate count is a procedure for estimating the number of live heterotopic bacteria in the water. Colonies may form in pairs, clusters or single cells, which can be termed as “colony-forming units”.

Dental unit water is the dental unit water system's encompassing fluid that is used for dental operative procedures. All dental unit water including treated dental unit water are susceptible to contamination. The CDC (Centers for Disease Control), recommends that dental unit water used in non-surgical procedures measures less than or equal to 500 colony forming units of heterotrophic bacteria per milliliter (≤500 CFU/mL) of water, which is also the standard set for drinking water by the EPA (Environmental Protection Agency), APHA (American Public Health Association), and the AWWA (American Water Works Association).

A dental unit water system's components comprises of fluid conduit(s) are dental unit waterlines; fluid reservoir(s) are dental water bottle(s) and/or dental water heater(s); valves; and the device(s) are dental handpieces and three-way syringe(s).

The dental water bottle is a fluid reservoir for the dental unit water. The dental water bottle is attached to the dental unit manifold. This manifold has a dental unit waterline called a dental water bottle pick-up tube that transports the dental unit water from the dental water bottle to the handpieces and three-way syringes.

Dental unit waterlines (DUWLs) are narrow-bore tubing used to deliver dental unit water for high-speed dental handpieces, air-water syringes, and dental unit water quick disconnects.

Contamination adheres to the inner tubal walls of dental unit waterlines. The ADA (American Dental Association) confirms research showing that a dental unit had high CFU counts as high as 200,000 CFU/mL within 5 days of installing new dental unit waterlines.

Contamination inside the dental unit water system affects the dental unit water quality. When the dental unit water becomes bacterial penetrated by the contaminated dental unit water system, this dental unit water's taste, composition and water quality are altered.

A combination of any of the following encourages rapid growth of microorganisms in the dental unit water system: stagnant dental unit water, warm dental unit water temperatures, dental water heaters, small dental unit waterlines tubing diameter, dead ends on dental unit, backflow of oral fluids from patient, handpiece connectors disconnected, poor hygienic ethics by dental office staff, contaminated dental water bottle pick-tube, contaminated dental water bottles, and dental unit water source.

Stagnant dental unit water remaining in this dental unit water system's components creates contamination. The small lumen of the dental unit's waterlines and the small amount of dental unit water used for dental procedures creates stagnant water, which increases the contamination of the dental unit water. This contamination forms on the inner walls of the dental unit waterlines, passages of valves and other said components with dental unit water flow.

A dead end is a blocked waterline within the dental unit. A dead end on a dental unit is a point at which the dental unit water does not continuously flow and is stopped by a valve. A dead end is a harbor of contamination if not properly cleaned.

Dead end examples are the water quick disconnect, slow speed handpiece waterline and/or a water pressure gauge connected to a waterline.

Backflow of oral fluids from a patient is caused when a dental high-speed handpiece's turbine creates a vacuum that sucks the patient's oral fluids back into this handpiece, which leads to contaminating the dental unit waterlines.

Contamination in the dental unit water system can occur when a dental office has poor hygienic ethics by not following protocols, not cleaning dental unit water system, not washing hands properly, and not wearing gloves. Even if a staff member is wearing gloves, the gloves are not sterile. A staff member can cause contamination within the dental unit water system when touching dental system's components.

When handpiece connectors are disconnected, these connectors are exposed and susceptible to contamination from aerosolization of contaminates in dental operatory and being touched by staff members.

There are many examples how the dental water bottle pick-up tube becomes contaminated. When re-attaching the dental water bottle to the dental unit, the pick-up tube's external surfaces are contaminated when a staff member touches this pick-up tube when inserting said tube inside the dental water bottle. The staff members' gloves are not sterile. This pick-up tube's contaminated external surface leads to further contamination in the dental unit water of the dental water bottle. Furthermore, this contaminated dental unit water contained by a dental water bottle will then contaminate this bottle.

When the dental water bottle is not attached to the dental unit, the pick-up tube becomes exposed to aerosols and atmospheric contaminants. This is an example of pick-up tube contamination.

The high-density polyethylene (HDPE) plastic dental water bottles are susceptible to contamination. Dental unit water remaining in a dental water bottle becomes stagnant, a contributing factor to growth of contaminates. Contamination adheres to the inner walls of the dental water bottle. Another example of a contaminated dental water bottle is when the inside of the dental water bottle are not being cleaned on a routine basis before filling it with dental unit water source.

All dental unit water sources are susceptible to contamination. Dental unit water without an antimicrobial agent will become more contaminated than water treated with an antimicrobial agent. The common dental unit water sources are municipal water, distilled water, spring bottled water, and well water.

The municipal drinking water source is treated with chlorine, an antimicrobial agent, to ensure this water is a safe drinking water for the community. However, not all cities have quality drinking water. Depending on the geographic area, some cities may have hard municipal water.

When dental offices have hard municipal water for their dental unit water, the hard water mineral deposits: calcium, magnesium, and iron contribute to contamination growth in the dental unit, clog dental unit waterlines, and cause a low water flow from the high-speed handpieces and air-water syringes. These mineral deposits from the hard municipal water can also impact the life span of some dental cleaning products; however, the present invention's chemical composition is not affected by a dental office's water source.

Distilled water source and spring bottled water source have a 24-hour shelf life once opened, since they do not contain an antimicrobial agent.

Dental offices in the rural areas that use well water as their dental unit water source do not contain any antimicrobial agents.

All dental unit water sources including treated dental unit water are susceptible to contamination. Examples of treated dental unit water: municipal water, filtered water, UV treated water, purified water, spring bottled water, and distilled water.

The dental water treatment products do not clean dental unit waterlines. Presently, a common misconception in dentistry is the difference between water treatment products and dental waterline cleaning products.

Dental water treatment products only treat dental unit water. Water treatment products and treated dental unit water do not remove contamination from the dental unit waterlines.

For example, treated dental unit water is supplied to contaminated dental unit waterlines. This treated dental unit water becomes bacterially penetrated and contaminated when contacting the contaminated dental waterlines, which increases the CFU count in this dental unit water. This results with contaminated dental unit water being dispensed for dental procedures.

Dental waterline cleaning products used routinely to clean the contamination in the dental unit water system helps maintain and control the dental unit water quality. Dental waterline cleaning products do not treat dental unit water.

Contamination occurs in the dental unit water system even when treated dental unit water is present. Water treatment products refer in their product instructions to use a dental waterline cleaning product to ‘shock’ the dental waterlines. The term, “shocking” is a marketing term created and replaced the word, “clean”. Shocking means to clean the dental unit waterlines.

The water treatment products refer to use a dental waterline cleaning product, because water treatment products and treated dental unit water do not clean the contamination from the dental unit waterlines. Water treatment products only treat dental unit water and supply this water to the contaminated dental unit waterlines, which causes this dental unit water to become contaminated.

Most common water treatment products exist in the form of tablets, water filters, cartridges, straws, and water purification systems.

Filters have no effect on contamination in dental unit waterlines. Dental unit water passes through the porous material in order to separate particulates or biological matter. Matter separated depends on the physical characteristic of the filter material. To remove most bacteria, filters must have a pore of 0.2 microns or less. A filter is found in various locations of the dental unit water system depending on the type of filter. Filters collect planktonic bacteria and the filter can become blocked from not being cleaned or replaced with a new filter. The blockage filter is an example of a dead end, which is a blocked water passage within the dental unit water system, which increases the CFU count in the dental unit water. The life span of this filter depends on the quality of dental unit water. The dental unit water system with a filter usually remains connected to municipal water.

Another form of a water treatment product is a resin filled cartridge impregnated with chemicals that function by the dental unit water or air passing through the cartridge on the chemically impregnated resin. The dental unit water and/or air picks up the chemical agent. This cartridge method requires using a dental waterline cleaning product periodically to remove contamination in the dental unit water system to ensure effectiveness of the cartridge.

Ultra violet lights improves the quality of incoming dental unit water by killing bacteria that pass in front of the UV light in the waterline. The UV light does not have an effect on contamination in the dental unit water system.

Water distillers may improve dental unit water quality. This water treatment method is used with any dental unit equipped with dental water bottles. If dental unit waterlines and dental water bottles are not properly maintained and the distiller malfunctions, this water treatment method will produce bacterially contaminated water.

Chemicals for continuous water treatment mixed with dental unit water inactivate suspended bacteria. This water treatment method is usually used continuously during patient treatment, but has little to no effect on contamination in the dental unit water system.

The present invention's chemical composition may be used for an intermittent treatment that cleans the contamination in the dental unit water system, which helps maintain and control the dental unit water quality. This chemical composition is compatible with all dental units and is utilized when patients are not present in the dental operatory.

In conclusion, dental unit water treatment products have no effect on the contamination growth in the dental unit water system. All dental unit water including treated dental unit water are susceptible to contamination growth regardless of the dental unit water source used and if a water treatment product treated the dental unit water.

A cleaning product such as this invention's chemical composition must be used routinely to clean the contamination in a dental unit water system in order to maintain the CDC's recommended dental unit water quality standards.

Earlier in my U.S. Patents:
1. U.S. Pat. No. 4,668,190 I disclosed a liquid admixing apparatus for dental water-injection systems. Liquid admixing means for a dental oral water-injection system are provided for introducing an additive liquid from a reservoir through an additive tube into a water conduit in the water-injection system wherein a valve in the additive tube can be opened and closed remotely by manually operable means.
2. U.S. Pat. No. 4,695,255 I disclosed a method of cutting and lubricating human hard tissue during power tool cutting wherein the tissue subjected to cutting has directed against it a liquid admixture of water as a cooling agent, alcohol as an anti-infection agent and glycerin as a lubricant.
3. U.S. Pat. No. 5,318,443 I disclosed a method of flushing, disinfecting a dental turbine handpiece by forcing a pressurized solution of a disinfectant and lubricant simultaneously through an air drive line to the handpiece when is not in operation to flush dental debris through an exhaust line.
4. U.S. Pat. No. 5,443,385, I disclosed a method of disinfecting and lubricating a discrete dental-medical device which comprises immersing the device in a water-alcohol-glycerin-chlorhexidine solution which includes methylcellulose as a lubrication-enhancing and film-forming agent and polyglycol as an antifoaming agent, followed by autoclaving the device.
5. U.S. Pat. No. 5,785,523 I disclosed a system integral with a dental unit. This improved system flushes and disinfects all waterlines of the dental unit.
6. U.S. Pat. No. 6,250,920 I disclosed a system that is detachable to purge a dental unit. This portable system can be taken from one dental unit to another dental unit to flush and disinfect the primary waterline and devices.

Neither of my prior art references discloses a chemical composition comprising to clean and/or lubricate fluid encompassing systems.

### SUMMARY OF THE INVENTION

The present invention provides a single chemical composition comprising to clean and/or lubricate fluid encompassing systems which comprises a composition about 25% to 75% by volume of water, about 5% to 35% by volume of alcohol, about 10% to 50% by volume of glycerin, and about 0.06% to about 2.0% by volume of chlorhexidine gluconate. This chemical composition's ingredients are water-soluble that does not leave residue and does not create corrosion within fluid encompassing systems.

This present invention's chemical composition comprising to clean and/or lubricate fluid encompassing systems and said systems' components comprising of fluid conduit(s), and/or fluid reservoir(s), and/or valve(s), and/or device(s). These components will become contaminated if not cleaned properly.

This chemical composition comprises to clean and/or lubricate discrete components for a fluid encompassing system such as a fluid reservoir(s) that are independently encompassing a fluid with and/or without a fluid encompassing system, which may be a mixing tank and/or dental water bottle. The term, “discrete” as used herein means a fluid component(s) that encompass a fluid independently with and/or without a fluid encompassing system.

The invention's chemical composition lubricates the surfaces of this system's components. Lubricating this system's components such as valves helps maintain the functioning of said device(s). This invention's chemical composition also cleans the contamination of this system, which also helps maintain the chemical and physical properties for this system's encompassing fluid. This chemical composition also improves this system's fluid flow and helps eliminate odor and foul tasting contamination from this system.

Overall, this invention's single chemical composition that is formulated to both clean the contamination in the system and also lubricate the system helps enhance this system's operation and efficiency. When this chemical composition is utilized routinely helps prolong the life span of this system and this system's components.

### DESCRIPTION OF THE PREFERRED EMBODIMENT

It is appropriate to define the terms used herein for the ingredients of this invention's chemical composition. The term, “chemical composition” as used herein means this invention's chemical composition which comprises about 25% to 75% by volume of water, about 5% to 35% by volume of alcohol, about 10% to 50% by volume of glycerin, and about 0.06% to about 2.0% by volume of chlorhexidine gluconate.

The preferred embodiment of this chemical composition is specifically formulated comprising to clean and/or lubricate fluid encompassing systems. The term, “clean” as used herein means this invention's chemical composition may sanitize, and/or treat, and/or clean, and/or disinfect fluid encompassing systems. The efficacy of this chemical composition's disinfectant properties may depend on how a method utilizes this chemical composition for fluid encompassing systems and components. For example, if a method using this chemical composition mixes and/or dilutes this chemical composition, then this will weaken this chemical composition's disinfecting properties. This chemical composition is preferably used with a method that does not alter this chemical composition's physical and chemical properties, which ensures this chemical composition's effectiveness is not compromised.

This chemical composition's ingredient, water, is treated by a ultra-violet light, deionization, filtration, reverse osmosis, and a water softening process in order to ensure this treated water is considered pure, which helps maintain the efficacy of the ingredients in this chemical composition. Untreated water used as an ingredient for this chemical composition affects the chemical properties of this chemical composition.

This chemical composition's ingredient, chlorhexidine gluconate, is a disinfectant and is commercially available in fluid form as chlorhexidine.

This chemical composition's ingredient, glycerin, is a lubricant, other than a petroleum-based product. Glycerin lubricates this fluid encompassing system, which improves this system's operation and efficiency. Glycerin is a very useful plasticizer and helps maintain the flexibility of said fluid conduit(s) that may be comprised of polyurethane, rubber, plastic, and silicone material. Glycerin is a trihydric alcohol and a humectant. This glycerin is a commercial kosher grade suitable for human consumption.

This chemical composition's ingredient, alcohol, is a denatured ethanol. This chemical composition's ingredient, denatured ethanol, uses spearmint or peppermint as denaturants. This chemical composition's denaturants, peppermint and spearmint, are flavoring agents that indicate when a method that uses this chemical composition is not performed correctly. For example, after a method using said chemical composition comprising to clean and/or lubricate said system is completed, if a mint taste from said flavoring agent(s) is present in said system's end encompassing fluid, then this indicates said chemical composition remains in said system.

This chemical composition's ingredients, glycerin and the denaturants from the denatured ethanol, help mask the foul odors that are caused by the contamination in said contaminated system. This chemical composition has a shelf life comprising of two years which comprises of this chemical composition's following ingredients: chlorhexidine gluconate and alcohol (ethanol alcohol and glycerin, a trihydric alcohol) are preservatives for said chemical composition.

This chemical composition may include a cosmetic ingredient, a coloring agent, which comprises about 0.0002% to about 0.0005% by volume of its content in said composition. This chemical composition's coloring agent serves as an indictor to show a different color from said system's encompassing fluid.

This chemical composition ingredient's percentage volumes of glycerin (trihydric alcohol), and chlorhexidine gluconate formulated together are this chemical composition's disinfectant ingredients.

Any method may be used with this chemical composition to clean and/or lubricate a fluid encompassing system, but preferably a method that will not change this chemical composition's comprising disinfectant and/or lubricating properties.

This chemical composition is preferably used with a method that does not alter this chemical composition's physical and chemical properties. This unaltered chemical composition that is added into a preferred empty fluid encompassing system ensures this chemical composition directly targets this system's contamination, which will create both a physical and chemical reaction on the contamination in this fluid encompassing system.

A physical reaction occurs when said composition's disinfectant ingredient, glycerin, also a humectant, attracts water from within the contamination cell structure causing a change in the physical properties. A chemical reaction occurs when said composition's disinfectant ingredient, chlorhexidine gluconate, alters the contamination.

This chemical composition has a pH between 4.0 and 6.5. This chemical composition preferred embodiment is a liquid with water-soluble ingredients that does not leave residue and does not create corrosion within said system. This chemical composition does not contain ingredients that attract bacteria such as sweetener ingredients.

This chemical composition comprising to clean and/or lubricate fluid encompassing systems, which may also include said systems' components comprising of fluid conduit(s), and/or fluid reservoir(s), and/or valve(s), and/or device(s). These components for a fluid encompassing system such as a fluid reservoir(s), which may be a mixing tank and/or dental water bottle, can also be discrete fluid components. The term, “discrete” as used herein means a fluid component(s) that encompass a fluid independently with and/or without a fluid encompassing system. These components will become contaminated if not cleaned properly.

This system and components become contaminated regardless if this system's encompassing fluid quality is treated. This contaminated system contaminates the treated encompassing fluid. Some of the aforementioned factors that contribute to contamination growth in this system, such as a slow moving fluid in the system, the system's stagnant fluid, and from human contamination, which also contaminates this system's encompassing fluid.

This invention's chemical composition cleans the contamination growth in a fluid encompassing system and components. When this chemical composition is used routinely to clean this system's contamination, this also helps maintain and control the chemical and physical properties for this system's encompassing fluid. This chemical composition also improves this system's fluid flow and helps eliminate odor and foul tasting contamination from this system.

This chemical composition can remain in said fluid encompassing system and components when this system is not being utilized comprising of consecutive days until this system is ready to be utilized again.

After this chemical composition cleans and/or lubricates all fluid encompassing systems and components, this chemical composition and contamination must be removed from these systems. This removal process ensures that this chemical composition and contamination are not consumed and does not remain in this system, which could alter the chemical and physical properties for said system's encompassing fluid.

This chemical composition is specifically formulated comprising to both clean the contamination in this system and also to lubricate this system. This chemical composition lubricates the surfaces of this system's components. Lubricating this system's components such as valves helps improve the functioning of said device(s) and said system.

When this chemical composition is utilized routinely, this chemical composition enhances this system's operation and efficiency, which helps prolong the life span of this fluid encompassing system and this system's components.

This chemical composition comprises to clean and/or lubricate wherein a fluid encompassing system is a dental unit water system; said system's encompassing fluid is dental unit water; the fluid conduit(s) are dental unit waterlines; the fluid reservoir(s) are dental water bottle(s) and/or dental water heater(s); valves; and the device(s) are dental handpieces and three-way syringe(s).

The present invention's chemical composition is comprised to be used routinely as an intermittent treatment to clean the contamination in the dental unit water system, which helps maintain and control the dental unit water quality. This chemical composition is compatible with all dental units and is used when patients are not present in the dental operatory to prevent patient exposure to said composition and/or contamination.

Contamination will still grow in this dental unit water system regardless of the dental unit water source and water treatment products used in the dental office. Establishing standards for dental unit water quality is part of the equation; however, even if a dental office takes precautions to treat their dental unit water source, this step does not address the contamination in the dental unit water system and components. This system and components become contaminated regardless if the dental unit water is treated based on the many aforementioned factors that contribute to contamination growth in this system, such as a slow moving dental unit water, the system's stagnant dental unit water and from human contamination.

Dental offices should implement this invention's chemical composition into their infection control protocol routinely in order to clean and control the contamination in this dental unit water system to ensure quality dental unit water is provided to patients that consistently meets the recommended CDC water standards. This chemical composition also lubricates this system's valves and improves said system's operation and efficiency. Cleaning and lubricating this system routinely with this chemical composition helps maintain and prolong the life span of this system and components.

This invention's chemical composition is comprised to clean and/or lubricate a draft beer keg dispensing system, another common example of a fluid encompassing system.

This draft beer keg dispensing system's encompassing/dispensing fluid is draft beer; wherein said beer system's components comprising the fluid conduit(s) are keg beer line(s) and/or pressurized gas line(s); the fluid reservoir(s) are beer keg(s), and/or pressurized said composition container(s), and/or pressurized gas cylinder(s); the valve(s) are a keg coupler(s) and/or pressure regulator(s); and the device(s) are a encompassing beer faucet(s) and/or encompassing beer faucet handle(s). Draft beer, the encompassing fluid for a draft beer keg dispensing system, flows through a keg line, a fluid conduit, from the keg beer, a fluid reservoir, to the dispensing beer faucet, a device.

The contamination in this beer system is a build up of contamination on the surfaces of this system's components. Contamination in said beer system also contaminates the beer, which alters the beer's taste. This chemical composition is performed routinely to clean this beer keg system, which will provide the consumer a consistent beer quality that is not contaminated.

This chemical composition is compatible with all draft beer keg dispensing systems. After this chemical composition cleans and/or lubricates this beer dispensing system, this chemical composition and contamination must be removed from this beer dispensing system before this system's encompassing fluid, draft beer, is dispensed for consumption. This removal process comprising of this chemical composition and contamination, ensures that the taste and quality (chemical and physical properties) of said system's dispensing/encompassing fluid, draft beer, is not altered and/or contaminated.

This invention's chemical composition comprises to clean and/or lubricate all fluid encompassing systems that dispenses a fluid or fluids for in vitro and/or in vivo procedures and/or for consumption. Industries that use a fluid encompassing system must also use a cleaning product such as this invention's chemical composition in order to address the contamination in this system and components. Fluid encompassing systems must be cleaned, because they are susceptible to contamination growth.

This invention's chemical composition performed routinely cleans and controls the contamination in these systems, which ensures this system's end product, the encompassing fluid, is not contaminated. This chemical composition enhances this system's operation and efficiency, which helps prolong the life span of fluid encompassing systems and these systems' components.

We claim:

1. A single chemical composition comprising to clean fluid encompassing systems which comprises
a) a chemical composition comprising
i. about 25% to 75% by volume of water,
ii. about 5% to 35% by volume of alcohol,
iii. about 10% to 50% by volume of glycerin,
iv. about 0.06% to about 2.0% by volume of chlorhexidine gluconate;
b)this chemical composition comprising to clean and/or to lubricate fluid encompassing systems and this systems' components comprising of fluid conduit(s), and/or fluid reservoir(s), and/or valve(s), and/or devices.

2. A chemical composition according to claim 1 wherein this chemical composition's ingredient, water, is treated by a ultra-violet light, deionization, filtration, reverse osmosis, and a water softening process in order to ensure this treated water is considered pure, which maintains the efficacy of the chemical ingredients in this chemical composition.

3. A chemical composition according to claim 1 wherein glycerin is a lubricant, other than a petroleum-based product.
a) Glycerin lubricates this fluid encompassing system, which improves this system's operation and efficiency.

4. A chemical composition according to claim 3 wherein the lubricant is a trihydric alcohol.

5. A chemical composition according to claim 4 wherein the trihydric alcohol is glycerin.

6. A chemical composition according to claim 1 wherein this chemical composition ingredient's percentage volumes of glycerin (trihydric alcohol) and chlorhexidine gluconate formulated together in this composition are both disinfectant ingredients.

7. A method according to claim 1 wherein any method may be used with this chemical composition to clean and/or lubricate all fluid encompassing systems, but preferably a method that will not change this chemical composition's comprising disinfectant and/or lubricating properties.
a) this chemical composition is preferably used with a method that does not alter this chemical composition's physical and chemical properties. This unaltered chemical composition that is added into a preferred empty fluid encompassing system and/or system's empty components ensures this chemical composition directly targets this system's contamination, which will create both a physical and chemical reaction on the contamination in this fluid encompassing system comprising of
i. a physical reaction occurs when said composition's disinfectant ingredient, glycerin, also a humectant, attracts water from within the contamination cell structure causing a change in the physical properties; and
ii. a chemical reaction occurs when said composition's disinfectant ingredient, chlorhexidine gluconate, alters the contamination.

8. A chemical composition according to claim 1 wherein this chemical composition is specifically formulated comprising to both clean the contamination in this system and to lubricate this system.

9. A chemical composition according to claim 1 wherein this chemical composition is used routinely to clean this system's contamination, which helps maintain and control the chemical and physical properties for this system's encompassing fluid.

10. A chemical composition according to claim 1 wherein this chemical composition's ingredient, alcohol, is a denatured ethanol which comprises
a) this chemical composition's ingredient, denatured ethanol, uses spearmint or peppermint as denaturants;
b) this chemical composition's denaturants, peppermint and spearmint, are flavoring agents that indicate when a method that uses this chemical composition is not performed correctly comprising of
i. after a method using said chemical composition comprising to clean and/or lubricate said system is completed, if a mint taste from said flavoring agent(s) is present in said system's end encompassing fluid, then this indicates said chemical composition remains in said system; and
c) this chemical composition's ingredients, glycerin and the denaturants from the denatured ethanol, help mask the foul odors that are caused by the contamination in said contaminated system;
d) this chemical composition has a shelf life comprising of two years which comprises
i. this chemical composition's following ingredients: chlorhexidine gluconate and alcohol (ethanol alcohol and glycerin, a trihydric alcohol) are preservatives for said chemical composition.

11. A chemical composition according to claim 1 wherein this chemical composition includes a cosmetic ingredient, a coloring agent, which comprises about 0.0002% to about 0.0005% by volume of its content in said chemical composition, which comprises
a) this chemical composition's coloring agent is an indictor to show a different color from said system's encompassing fluid.

12. A chemical composition according to claim 1 wherein this chemical composition has a pH between 4.0 and 6.5.

13. A chemical composition to claim 1 wherein this chemical composition is a liquid with water-soluble ingredients that does not leave residue and does not create corrosion within said system.

14. A chemical composition according to claim 1 wherein this chemical composition can remain in said fluid encompassing system and components when this system is not being utilized comprising of consecutive days until this system is ready to be utilized again.

15. A chemical composition according to claim 1 wherein this chemical composition does not contain ingredients that attract bacteria, such as sweetener ingredients.

16. A chemical composition according to claim 1 wherein this chemical composition is performed routinely to help clean and control the contamination in this system, which helps maintain this system's encompassing fluid's physical and chemical properties.

17. A chemical composition according to claim 1 wherein this chemical composition improves said system's operation and efficiency by prolonging the life span of said system and this system's components which comprises by
a) lubricating said valve(s) helps enhance the functioning of said system(s);
b) cleaning said system by directing said chemical composition upon the contamination on the surfaces of said system and said system's components;
c) eliminating odor and foul tasting contaminates from said system;
d) improving the flow of said system's fluid; and
e) maintaining flexibility of said fluid conduit(s) that may be comprised of polyurethane, rubber, plastic and silicone material from said chemical composition's ingredient, glycerin, which is a very useful plasticizer.

18. A method according to claim 1 wherein after this chemical composition cleans and/or lubricates fluid encompassing systems and components, this chemical composition and contamination is removed from these systems.
a) This removal process ensures that this comprising chemical composition and contamination are not consumed and does not remain in this system, which could alter the chemical and physical properties for said system's encompassing fluid.

19. A chemical composition according to claim 1 wherein this chemical composition is formulated without harsh chemicals that is designed to clean and protect the surfaces of this system's components from buildup of contamination without the use of other supplemental cleaning products.

20. A chemical composition according to claim 1 wherein this chemical composition comprises to clean and/or lubricate fluid encompassing system is a dental unit water system; said system's encompassing fluid is dental unit water; this system's components comprises of the fluid conduit(s) are dental unit waterlines; the fluid reservoir(s) are dental water bottle(s) and/or dental water heater(s); valves; and the device(s) are dental handpieces and three-way syringe(s) which comprises
a) this chemical composition is compatible with all dental units;
b) this chemical composition is performed routinely comprising an intermittent treatment that maintains and controls the dental unit water quality by cleaning the contamination of said dental water system, which improves the efficiency and operation of this system;
c) this chemical composition can remain in this system and components when this system is not being utilized when patients are not present in the same dental operatory in order to prevent patient exposure to said composition and/or contamination; and
d) after this chemical composition cleans and/or lubricates this dental unit water system, this chemical composition and contamination must be removed from this system before this system's encompassing fluid, dental unit water, is dispensed for dental procedures;
i. this removal process comprising of this chemical composition and contamination, ensures that the dental unit water quality (chemical and physical properties) of said system's dispensing/encompassing fluid, dental unit water, is not altered and/or contaminated.

21. A chemical composition according to claim 1 wherein this chemical composition comprises to clean and/or lubricate discrete components such as fluid reservoir(s), that are independently encompassing a fluid with and/or without a fluid encompassing system is a dental water bottle(s); thermos; water jugs; encompassing coolers; beverage containers; canteens; casks; non-dishwasher safe fluid reservoirs; flasks; fluid reservoirs with long fluid reservoir necks; mixing tanks; vats; kettle; teapot; pot still; a distillation apparatus; and other fluid encompassing reservoirs.

22. A chemical composition according to claim 1 wherein this chemical composition comprises to clean and/or lubricate draft beer keg dispensing systems, a fluid encompassing system; this system's encompassing/dispensing fluid is draft beer; wherein said beer system's components comprising the fluid conduit(s) are keg beer line(s) and/or pressurized gas line(s); the fluid reservoir(s) are beer keg(s), and/or pressurized said chemical composition container(s), and/or pressurized gas cylinder(s); the valve(s) are a keg coupler(s) and/or pressure regulator(s); and the device(s) are a encompassing beer faucet(s) and/or encompassing beer faucet handle(s) which comprises
a) this chemical composition is compatible with all draft beer keg dispensing systems;
b) this chemical composition is performed routinely to clean this beer keg system, which will provide a consistent beer quality that is not contaminated;
c) after this chemical composition cleans and/or lubricates this beer dispensing system, this chemical composition and contamination must be removed from this beer dispensing system before this system's encompassing fluid, draft beer, is dispensed for consumption;
i. this removal process comprising of this chemical composition and contamination, ensures that the taste and quality (chemical and physical properties) of said system's dispensing/encompassing fluid, draft beer, is not altered and/or contaminated.

23. A chemical composition according to claim 1 wherein this chemical composition comprises to clean and/or lubricate all fluid encompassing systems and/or components wherein a fluid encompassing system is a distillation apparatus; distiller(s); pot still(s); surgical laser system(s); blood transfusion machine(s); medical/dental systems that encompass fluid(s); dairy milking operation system(s); pressurized fluid encompassing system(s); dental unit water system(s); catheter(s); beverage brewing system(s); coffee maker(s); machine(s) for beverages such as tea, hot chocolate, apple cider and/or coffee; kettle(s); teapot(s); draft beer keg system with encompassing beer faucet(s); soda fountain encompassing machine(s); kidney dialysis machine(s); sleep apnea machine(s); ice cream/frozen yogurt encompassing machine(s); beverage container(s) with dispenser; water cooler machine(s); wine encompassing machine(s); frozen beverage encompassing machine(s); and other fluid encompassing systems(s).
